(19) United States
(12) Patent Application Publication
(10) Pub. No.: US 2014/0292759 A1
(43) Pub. Date: Oct. 2, 2014

(54) Method, Apparatus and Computer Program Product for Managing Media Content

(71) Applicants: Chethan Palakshamurthy, Bangalore (IN); Sidharth Patil, Bangalore (IN); Sujay Patil, Bangalore (IN)

(72) Inventors: Chethan Palakshamurthy, Bangalore (IN); Sidharth Patil, Bangalore (IN); Sujay Patil, Bangalore (IN)

(73) Assignee: NOKIA CORPORATION, Espoo (FI)

(21) Appl. No.: 14/009,364

(22) PCT Filed: Mar. 2, 2012
(86) PCT No.: PCT/FI12/50208

§ 371 Date: Dec. 9, 2013

(30) Foreign Application Priority Data
Apr. 6, 2011 (IN) 1164/CHE/2011

(51) Int. Cl. G06T 3/00

(52) U.S. Cl. CPC G06T 3/0093
USPC 345/428

(57) ABSTRACT

In accordance with an example embodiment a method and apparatus is provided. The method comprises receiving a request for providing a first granularity level highlights associated with a media content. Presence of at least one of second granularity level highlights and third granularity level highlights associated with the media content is determined. The second granularity level highlights are finer than the first granularity level highlights and the third granularity level highlights are coarse than the first granularity level highlights. The first granularity level highlights are generated based on the determination of the presence of one of the second granularity level highlights and the third granularity level highlights.

### TECHNICAL FIELD

Various implementations relate generally to method, apparatus, and computer program product for managing media content by organizing highlights of the media content into multiple discrete granularity levels.

### BACKGROUND

The rapid advancement in technology related to capture and display of media content has resulted in an exponential growth of media content collection. Devices like mobile phones and personal digital assistants (PDA) are now being increasingly configured with video capture tools, such as a camera, thereby facilitating easy capture and storage of a large amount of media content.

With the growing size and complexity of the media content, the representation of the media is structured by providing highlights of the media content. The highlights associated with the media content may be provided to the user for the purpose of selection and browsing of the media content in a convenient manner. The highlights of the media content may contain thumbnails extracted from the media content. The highlights may act as representative of the media content corresponding to a single media segment or the entire media content. The user may browse through the highlights, and select only those highlights corresponding to the media segments of interest. The highlights enable the user to perform various actions associated with multimedia applications, such as text editing, video summarization, audio player, and the like in a convenient manner.

### SUMMARY OF SOME EMBODIMENTS

Various aspects of examples embodiments are set out in the claims.

In a first aspect, there is provided a method comprising: receiving a request for providing first granularity level highlights associated with a media content; determining presence of at least one of second granularity level highlights and third granularity level highlights associated with the media content, the second granularity level highlights being finer than the first granularity level highlights and the third granularity level highlights being coarse than the first granularity level highlights; and generating the first granularity level highlights based on the determination of the presence of one of the second granularity level highlights and the third granularity level highlights.

In a second aspect, there is provided an apparatus comprising: at least one processor; and at least one memory comprising computer program code, the at least one memory and the computer program code configured to, with the at least one processor, cause the apparatus at least to perform: receiving a request for providing first granularity level highlights associated with a media content; determining presence of at least one of a second granularity level highlights and third granularity level highlights associated with the media content, the second granularity level highlights being finer than the first granularity level highlights and the third granularity level highlights being coarse than the first granularity level highlights; and generating the first granularity level highlights based on the determination of the presence of one of the second granularity level highlights and the third granularity level highlights.

In a third aspect, there is provided a computer program product comprising at least one computer-readable storage medium, the computer-readable storage medium comprising a set of instructions, which, when executed by one or more processors, cause an apparatus to at least perform: receiving a request for providing first granularity level highlights associated with a media content; determining presence of at least one of second granularity level highlights and third granularity level highlights associated with the media content, the second granularity level highlights being finer than the first granularity level highlights and the third granularity level highlights being coarse than the first granularity level highlights; and generating the first granularity level highlights based on the determination of the presence of one of the second granularity level highlights and the third granularity level highlights.

In a fourth aspect, there is provided an apparatus comprising: means for receiving a request for providing first granularity level highlights associated with a media content; means for determining presence of at least one of second granularity level highlights and third granularity level highlights associated with the media content, the second granularity level highlights being finer than the first granularity level highlights and the third granularity level highlights being coarse than the first granularity level highlights; and means for generating the first granularity level highlights based on the determination of the presence of one of the second granularity level highlights and the third granularity level highlights.

In a fifth aspect, there is provided a computer program comprising program instructions which when executed by an apparatus, cause the apparatus to: receive a request for providing first granularity level highlights associated with a media content; determine presence of at least one of second granularity level highlights and third granularity level highlights associated with the media content, the second granularity level highlights being finer than the first granularity level highlights and the third granularity level highlights being coarse than the first granularity level highlights; and generate the first granularity level highlights based on the determination of the presence of one of the second granularity level highlights and the third granularity level highlights

### BRIEF DESCRIPTION OF THE FIGURES

The embodiments of the invention are illustrated by way of example, and not by way of limitation, in the figures of the accompanying drawings in which:

FIG. 1 illustrates a device in accordance with an example embodiment;

FIG. 2 illustrates an apparatus for managing media content by organizing highlights of the media content into multiple discrete granularity levels in accordance with an example embodiment;

FIG. 3 is a modular layout for a device for managing media content by organizing highlights of the media content into multiple discrete granularity levels in accordance with an example embodiment;

FIG. 4 is a block diagram illustrating generation of highlights from the highlights associated with coarse granularity level;

FIG. 5 is a block diagram illustrating generation of highlights from the highlights associated with finer granularity level;

FIG. 6 is a flowchart depicting an example method for managing media content by organizing highlights of the media content into multiple discrete granularity levels in accordance with an example embodiment; and

FIG. 7 is a flowchart depicting an example method for managing media content by organizing highlights of the media content into multiple discrete granularity levels in accordance with another example embodiment.

### DETAILED DESCRIPTION

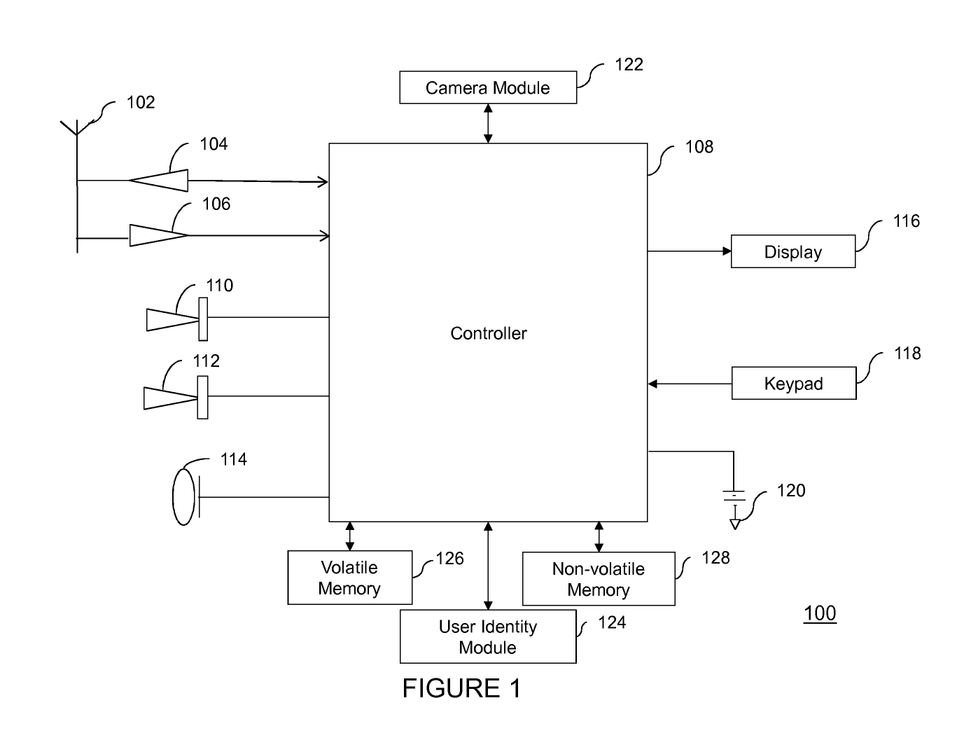

Example embodiments and their potential effects are understood by referring to FIGS. 1 through 7 of the drawings.

FIG. 1 illustrates a device 100 in accordance with an example embodiment. It should be understood, however, that the device 100 as illustrated and hereinafter described is merely illustrative of one type of device that may benefit from various embodiments, therefore, should not be taken to limit the scope of the embodiments. As such, it should be appreciated that at least some of the components described below in connection with the device 100 may be optional and thus in an example embodiment may include more, less or different components than those described in connection with the example embodiment of FIG. 1. The device 100 could be any of a number of types of mobile electronic devices, for example, portable digital assistants (PDAs), pagers, mobile televisions, gaming devices, cellular phones, all types of computers (for example, laptops, mobile computers or desktops), cameras, audio/video players, radios, global positioning system (GPS) devices, media players, mobile digital assistants, or any combination of the aforementioned, and other types of communications devices.

The device 100 may include an antenna 102 (or multiple antennas) in operable communication with a transmitter 104 and a receiver 106. The device 100 may further include an apparatus, such as a controller 108 or other processing device that provides signals to and receives signals from the transmitter 104 and receiver 106, respectively. The signals may include signaling information in accordance with the air interface standard of the applicable cellular system, and/or may also include data corresponding to user speech, received data and/or user generated data. In this regard, the device 100 may be capable of operating with one or more air interface standards, communication protocols, modulation types, and access types. By way of illustration, the device 100 may be capable of operating in accordance with any of a number of first, second, third and/or fourth-generation communication protocols or the like. For example, the device 100 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA1000, wideband CDMA (WCDMA) and time division-synchronous CDMA (TD-SCDMA), with 3.9G wireless communication protocol such as evolved-universal terrestrial radio access network (E-UTRAN), with fourth-generation (4G) wireless communication protocols, or the like. As an alternative (or additionally), the device 100 may be capable of operating in accordance with non-cellular communication mechanisms. For example, computer networks such as the Internet, local area network, wide area networks, and the like; short range wireless communication networks such as include Bluetooth® networks, Zigbee® networks, Institute of Electric and Electronic Engineers (IEEE) 802.11x networks, and the like; wireline telecommunication networks such as public switched telephone network (PSTN).

The controller 108 may include circuitry implementing, among others, audio and logic functions of the device 100. For example, the controller 108 may include, but are not limited to, one or more digital signal processor devices, one or more microprocessor devices, one or more processor(s) with accompanying digital signal processor(s), one or more processor(s) without accompanying digital signal processor(s), one or more special-purpose computer chips, one or more field-programmable gate arrays (FPGAs), one or more controllers, one or more application-specific integrated circuits (ASICs), one or more computer(s), various analog to digital converters, digital to analog converters, and/or other support circuits. Control and signal processing functions of the device 100 are allocated between these devices according to their respective capabilities. The controller 108 thus may also include the functionality to convolutionally encode and interleave message and data prior to modulation and transmission. The controller 108 may additionally include an internal voice coder, and may include an internal data modem. Further, the controller 108 may include functionality to operate one or more software programs, which may be stored in a memory. For example, the controller 108 may be capable of operating a connectivity program, such as a conventional Web browser. The connectivity program may then allow the device 100 to transmit and receive Web content, such as location-based content and/or other web page content, according to a Wireless Application Protocol (WAP), Hypertext Transfer Protocol (HTTP) and/or the like. In an example embodiment, the controller 108 may be embodied as a multi-core processor such as a dual or quad core processor. However, any number of processors may be included in the controller 108.

The device 100 may also comprise a user interface including an output device such as a ringer 110, an earphone or speaker 112, a microphone 114, a display 116, and a user input interface, which may be coupled to the controller 108. The user input interface, which allows the device 100 to receive data, may include any of a number of devices allowing the device 100 to receive data, such as a keypad 118, a touch display, a microphone or other input device. In embodiments including the keypad 118, the keypad 118 may include numeric (0-9) and related keys (#, *), and other hard and soft keys used for operating the device 100. Alternatively or additionally, the keypad 118 may include a conventional QWERTY keypad arrangement. The keypad 118 may also include various soft keys with associated functions. In addition, or alternatively, the device 100 may include an interface device such as a joystick or other user input interface. The device 100 further includes a battery 120, such as a vibrating battery pack, for powering various circuits that are used to operate the device 100, as well as optionally providing mechanical vibration as a detectable output.

In an example embodiment, the device 100 includes a media capturing element, such as a camera, video and/or audio module, in communication with the controller 108. The media capturing element may be any means for capturing an image, video and/or audio for storage, display or transmission. In an example embodiment in which the media capturing element is a camera module 122, the camera module 122 may include a digital camera capable of forming a digital image file from a captured image. As such, the camera module 122 includes all hardware, such as a lens or other optical component(s), and software for creating a digital image file from a captured image. Alternatively, the camera module 122 may include only the hardware needed to view an image, while a memory device of the device 100 stores instructions for execution by the controller 108 in the form of software to create a digital image file from a captured image. In an example embodiment, the camera module 122 may further include a processing element such as a co-processor, which assists the controller 108 in processing image data and an encoder and/or decoder for compressing and/or decompressing image data. The encoder and/or decoder may encode and/or decode according to a JPEG standard format or another like format. For video, the encoder and/or decoder may employ any of a plurality of standard formats such as, for example, standards associated with H.261, H.262/MPEG-2, H.263, H.264, H.264/MPEG-4, MPEG-4, and the like. In some cases, the camera module 122 may provide live image data to the display 116. Moreover, in an example embodiment, the display 116 may be located on one side of the device 100 and the camera module 122 may include a lens positioned on the opposite side of the device 100 with respect to the display 116 to enable the camera module 122 to capture images on one side of the device 100 and present a view of such images to the user positioned on the other side of the device 100.

The device 100 may further include a user identity module (UIM) 124. The UIM 124 may be a memory device having a processor built in. The UIM 124 may include, for example, a subscriber identity module (SIM), a universal integrated circuit card (UICC), a universal subscriber identity module (USIM), a removable user identity module (R-UIM), or any other smart card. The UIM 124 typically stores information elements related to a mobile subscriber. In addition to the UIM 124, the device 100 may be equipped with memory. For example, the device 100 may include volatile memory 126, such as volatile random access memory (RAM) including a cache area for the temporary storage of data. The device 100 may also include other non-volatile memory 128, which may be embedded and/or may be removable. The non-volatile memory 128 may additionally or alternatively comprise an electrically erasable programmable read only memory (EEPROM), flash memory, hard drive, or the like. The memories may store any number of pieces of information, and data, used by the device 100 to implement the functions of the device 100.

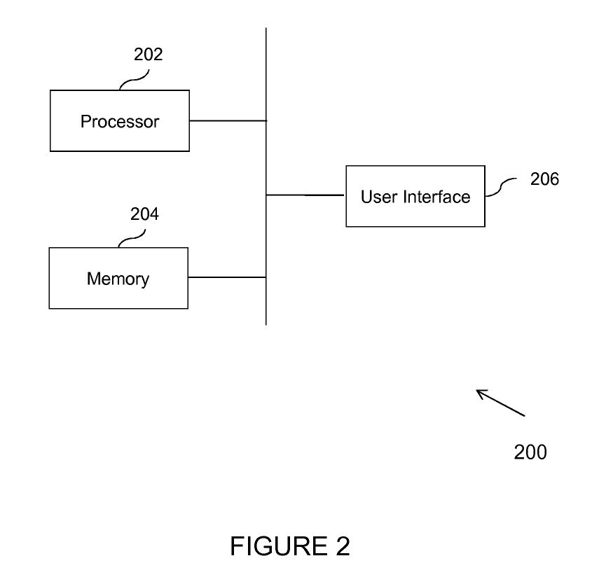

FIG. 2 illustrates an apparatus 200 for managing media content by organizing highlights of the media content into multiple discrete granularity levels in accordance with an example embodiment. The apparatus 200 may be employed, for example, in the device 100 of FIG. 1. However, it should be noted that the apparatus 200, may also be employed on a variety of other devices both mobile and fixed, and therefore, embodiments should not be limited to application on devices such as the device 100 of FIG. 1. In an example embodiment, the apparatus 200 is a mobile phone, which may be an example of a communication device. Alternatively or additionally, embodiments may be employed on a combination of devices including, for example, those listed above. Accordingly, various embodiments may be embodied wholly at a single device, for example, the device 100 or in a combination of devices. It should be noted that some devices or elements described below may not be mandatory and thus some may be omitted in certain embodiments.

The apparatus 200 includes or otherwise is in communication with at least one processor 202 and at least one memory 204. Examples of the at least one memory 204 include, but are not limited to, volatile and/or non-volatile memories. Some examples of the volatile memory includes, but are not limited to, random access memory, dynamic random access memory, static random access memory, and the like. Some example of the non-volatile memory includes, but are not limited to, hard disks, magnetic tapes, optical disks, programmable read only memory, erasable programmable read only memory, electrically erasable programmable read only memory, flash memory, and the like. The memory 204 may be configured to store information, data, applications, instructions or the like for enabling the apparatus 200 to carry out various functions in accordance with various example embodiments. For example, the memory 204 may be configured to buffer input data comprising media content for processing by the processor 202. Additionally or alternatively, the memory 204 may be configured to store instructions for execution by the processor 202.

An example of the processor 202 may include the controller 108. The processor 202 may be embodied in a number of different ways. The processor 202 may be embodied as a multi-core processor, a single core processor; or combination of multi-core processors and single core processors. For example, the processor 202 may be embodied as one or more of various processing means such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an example embodiment, the multi-core processor may be configured to execute instructions stored in the memory 204 or otherwise accessible to the processor 202. Alternatively or additionally, the processor 202 may be configured to execute hard coded functionality. As such, whether configured by hardware or software methods, or by a combination thereof, the processor 202 may represent an entity, for example, physically embodied in circuitry, capable of performing operations according to various embodiments while configured accordingly. For example, if the processor 202 is embodied as two or more of an ASIC, FPGA or the like, the processor 202 may be specifically configured hardware for conducting the operations described herein. Alternatively, as another example, if the processor 202 is embodied as an executor of software instructions, the instructions may specifically configure the processor 202 to perform the algorithms and/or operations described herein when the instructions are executed. However, in some cases, the processor 202 may be a processor of a specific device, for example, a mobile terminal or network device adapted for employing embodiments by further configuration of the processor 202 by instructions for performing the algorithms and/or operations described herein. The processor 202 may include, among other things, a clock, an arithmetic logic unit (ALU) and logic gates configured to support operation of the processor 202.

A user interface 206 may be in communication with the processor 202. Examples of the user interface 206 include, but are not limited to, input interface and/or output user interface. The input interface is configured to receive an indication of a user input. The output user interface provides an audible, visual, mechanical or other output and/or feedback to the user. Examples of the input interface may include, but are not limited to, a keyboard, a mouse, a joystick, a keypad, a touch screen, soft keys, and the like. Examples of the output interface may include, but are not limited to, a display such as light emitting diode display, thin-film transistor (TFT) display, liquid crystal displays, active-matrix organic light-emitting diode (AMOLED) display, a microphone, a speaker, ringers, vibrators, and the like. In an example embodiment, the user interface 206 may include, among other devices or elements, any or all of a speaker, a microphone, a display, and a keyboard, touch screen, or the like. In this regard, for example, the processor 202 may comprise user interface circuitry configured to control at least some functions of one or more elements of the user interface 206, such as, for example, a speaker, ringer, microphone, display, and/or the like. The processor 202 and/or user interface circuitry comprising the processor 202 may be configured to control one or more functions of one or more elements of the user interface 206 through computer program instructions, for example, software and/or firmware, stored on a memory, for example, the at least one memory 204, and/or the like, accessible to the processor 202.

In an example embodiment, the apparatus 200 may include an electronic device. Some examples of the electronic device includes communication device, media playing device with communication capabilities, computing devices, and the like. Some examples of the communication device may include a mobile phone, a personal digital assistant (PDA), and the like. Some examples of computing device may include a laptop, a personal computer, and the like. In an example embodiment, the communication device may include a user interface, for example, the UI 206, having user interface circuitry and user interface software configured to facilitate a user to control at least one function of the communication device through use of a display and further configured to respond to user inputs. In an example embodiment, the communication device may include a display circuitry configured to display at least a portion of the user interface of the communication device. The display and display circuitry may be configured to facilitate the user to control at least one function of the communication device.

In an example embodiment, the communication device may be embodied as to include a transceiver. The transceiver may be any device operating or circuitry operating in accordance with software or otherwise embodied in hardware or a combination of hardware and software. For example, the processor 202 operating under software control, or the processor 202 embodied as an ASIC or FPGA specifically configured to perform the operations described herein, or a combination thereof, thereby configures the apparatus or circuitry to perform the functions of the transceiver. The transceiver may be configured to receive media content. Examples of media content may include audio content, video content, data, and a combination thereof.

In an example embodiment, the processor 202 is configured to, with the content of the memory 204, and optionally with other components described herein, to cause the apparatus 200 to manage the media content by organizing highlights of the media content into multiple discrete granularity levels. Examples of the media content may include video content, audio context, text data, and a combination thereof. The media content may include multiple media segments. The media segments may be associated with the highlights. The highlights corresponding to a media segment may be representative of the content of the media segment. In an example embodiment, the highlight may include a thumbnail, a frame, an image and the like, extracted from the media segment. In an example embodiment, the multiple media segments may be of same or different durations.

In an example embodiment, the media content may be accessed by a plurality of applications, such as a ‘Media Gallery’ application, a ‘Frame Stepping’ application, a ‘Text Editing’ application, a ‘Presentation Stepping’ application, a ‘Video Cuts’ application, and the like. Due to different requirements of each of the plurality of applications, a granularity level of the highlights of the media content required for different applications may be different. As referred herein, the term ‘granularity level’ may refer to the categorization of intent of the application. For example, intent of a ‘Media Gallery’ application may be to produce only one thumbnail that may be representative of contents of the gallery. Similarly, intent of a ‘Frame Stepping’ application may be to generate highlights, so that the playback of a video may be stepped by a particular number of frames. As such, the highlights required for the ‘Frame Stepping’ application are finer and of higher granularity level as compared to those required for the ‘Media Gallery’ application.

In an example embodiment, for an application requiring very coarse highlights of the media content may be assigned a granularity level ‘0’. Example of such an application may be a ‘Media Gallery’ application that may require a thumbnail for representation thereof. Similarly, a granularity level ‘1’ may refer to coarse highlights of the media content, but at a level where the media content as a whole may be described by the highlight. For example, an animated thumbnail on a media wall may be representative of the media document. The granularity level ‘2’ may be assigned to finer highlights of the media content for the purpose of presentation seeking, such as in a ‘Video cuts’ application, wherein only the key scenes may be displayed so that a user may select the scenes of interest and visually seek to the desired scenes.

In an example embodiment, the processor 202 is configured to, with the content of the memory 204, and optionally with other components described herein, to cause the apparatus 200 to facilitate receiving a request for providing first (for example, Nth) granularity level highlights associated with a media content. In an example embodiment, the request may be received from an application, such as, a ‘Media Gallery’ application. For example, the ‘Media Gallery’ application may request for presenting the first granularity level highlight representing an animated thumbnail in the ‘Media Gallery’. In an example embodiment, a transceiving means may be configured to receive request for providing first granularity level highlights associated with the media content. An example of the transceiving means may include the transceiver.

In an example embodiment, the processor 202 is configured to, with the content of the memory 204, and optionally with other components described herein, to cause the apparatus 200 to determine the presence of one of second (for example (N+i)th) granularity level highlights and third (for example, (N−i)th) granularity level highlights associated with the media content. In an example embodiment, the second granularity level highlights may be finer than the first granularity level highlights. In an example embodiment, the third granularity level highlights may be coarse than the first granularity level highlights. In an example embodiment, a processing means may be configured to determine the presence of one of second granularity level highlights and third granularity level highlights associated with the media content. An example of the processing means may include the processor 202, which may be an example of the controller 108. For the purpose of description, the terms ‘first granularity level’, the ‘second granularity level’ and the ‘third granularity level’ may be used interchangeably with the terms ‘Nth granularity level’, ‘(N+i)th granularity level’ and ‘(N−i)th granularity level’ respectively. The terms (N−i)th, Nth, (N+i)th as used herein may be representative of the granularity level of highlights in an order such that the (N+i)th granularity level highlights may be finer than the Nth granularity level highlights and the (N−i)th granularity level highlights may be coarse than the Nth granularity level highlights.

In an example embodiment, the processor 202 is configured to, with the content of the memory 204, and optionally with other components described herein, to cause the apparatus 200 to generate the first or the Nth granularity level highlights based on the determination of the presence of one of the second or the (N+i)th granularity level highlights and the third or the (N−i)th granularity level highlights. In an example embodiment, a processing means may be configured to generate the first granularity level highlights based on the determination of the presence of one of the second granularity level highlights and the third granularity level highlights. An example of the processing means may include the processor 202, which may be an example of the controller 108.

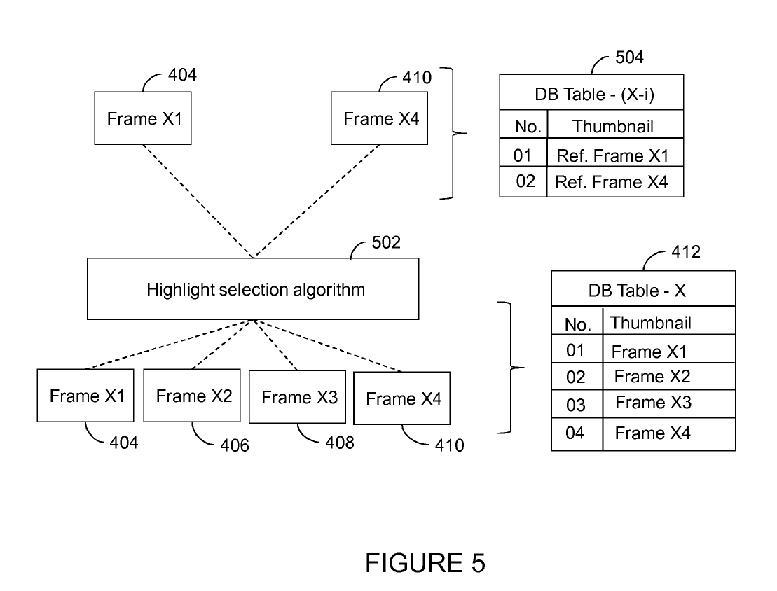

In an example embodiment, when the presence of the second (N+i)th granularity level highlights is determined, the first (Nth) granularity level highlights may be generated by extracting media segments corresponding to the first (Nth) level highlights from the second (N+i)th granularity level highlights that are finer than the first (Nth) level highlights. In an example embodiment, extracting the media highlights corresponding to the first granularity level highlights comprises applying a selection algorithm on the second granularity level highlights. The generation of the first (Nth) level highlights from the finer second (N+i)th granularity level highlights is explained in FIG. 5.

In another example embodiment, when the presence of the second granularity level highlights is determined, the first granularity level highlights are generated by extracting at least a portion of the media segmentation and other related information such as an information associated with the first granularity level highlights from the second granularity level highlights. The first granularity level highlights may be generated from the media content based on the extracted at least a portion of the media segmentation and the information.

In an example embodiment, the first or the Nth granularity level highlights may be generated based on the determination of the presence of the third (N−i)th granularity highlights. In an example embodiment, the first or the (N)th granularity level highlights may be generated by using the third (N−i)th granularity level highlights when the second (N+i)th granularity level highlights are determined to be absent. In an example embodiment, when the presence of third granularity level highlights is determined, the first granularity level highlights may be generated by fetching at least one media segment corresponding to the first granularity level highlights present in the third granularity level highlights, and retrieving, from the media content, the first granularity level highlights that are absent from the third granularity level highlights. For example, an application may request for the highlights associated with ‘Presentation seeking’ application. Another application may request for generating highlights associated with ‘Presentation Stepping’. In such a scenario, the highlights requested by the application ‘Presentation seeking’ may be of coarse granularity level as compared to those requested by the ‘Presentation Stepping’ application. The at least one media segments required for highlights of ‘Presentation Stepping’ application may be extracted from the highlights of ‘Presentation seeking’ application. In an example embodiment, extracting the highlights may include referring to the stored highlights. In an example embodiment, the at least one of the generated first granularity level highlights, the second granularity level highlights, and the third granularity level highlights are stored in one or more devices associated with a cloud. Examples of the one or more devices may include a server. In an example embodiment, the processor 202 is configured to, with the content of the memory 204, and optionally with other components described herein, to cause the apparatus 200 to provide a location reference information associated with the stored highlights for the purpose of extracting the stored highlights.

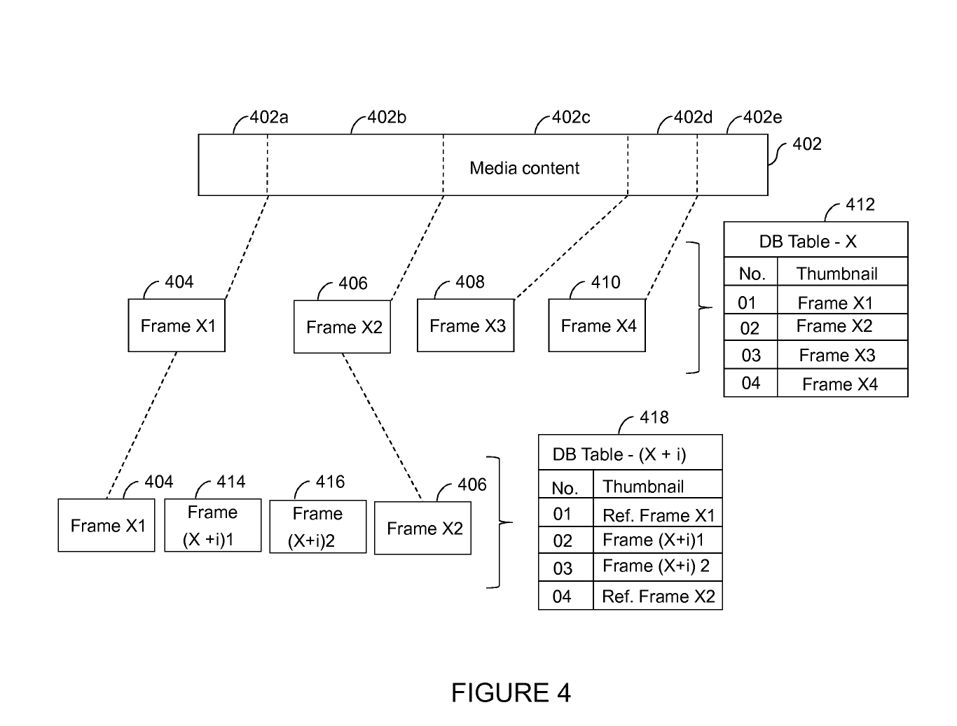

The remaining highlights, namely, the highlights absent from the third granularity level highlights, and requested by the ‘Presentation Stepping’ application, may be selected from the media content for completely generating the highlights for the ‘Presentation seeking’ application. The generation of the first level highlights from the coarse third granularity level highlights is explained in FIG. 4. In an example embodiment, a processing means may be configured to generate the first granularity level highlights based on the determination of the presence of the third granularity level highlights. An example of the processing means may include the processor 202, which may be an example of the controller 108.

In an example embodiment, the processor 202 is configured to, with the content of the memory 204, and optionally with other components described herein, to cause the apparatus 200 to generate the first granularity level highlights by utilizing the media content, in case the second granularity level highlights and the third granularity level highlights are determined to be absent. In an example embodiment, the first granularity level highlights may be generated by decoding the media content. In an example embodiment, the processor 202 is configured to, with the content of the memory 204, and optionally with other components described herein, to cause the apparatus 200 to store the generated first granularity level highlights. In an example embodiment, a processing means may be configured to facilitate provisioning of the media content for generating the first granularity level highlights. An example of the processing means may include the processor 202, which may be an example of the controller 108.

In an example embodiment, the generated first level highlights may be stored in form of tables. In another example embodiment, the generated first level highlights may be stored in form of arrays. The storing of the generated highlights in tables is explained in more detail in FIGS. 4 and 5. In an example embodiment, a memory means may be configured to store the generated first level highlights. An example of the memory means may include the memory 204.

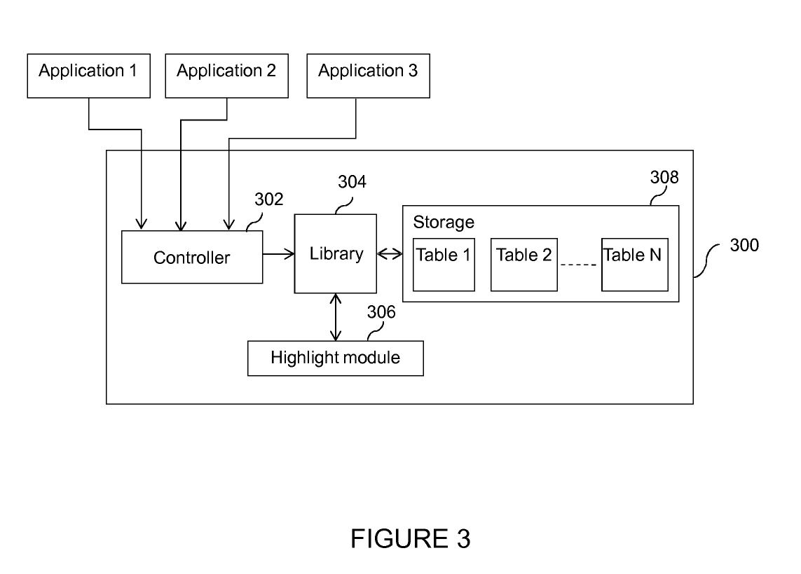

FIG. 3 is a component diagram for a device, for example a device 300 for managing media content by organizing highlights of the media content into multiple discrete granularity levels. The device 300 is broken down into components representing the functional aspects of the device 300. These functions may be performed by the various combinations of software and/or hardware components discussed below.

The device 300 may include a controller 302 for regulating the operations of the device 300. In an example embodiment, the controller may be embodied in form of a processor such as the processor 202. The controller may control various functionalities of the device 300 as described herein. For example, inputs may be received from various other components included within the device 300 and applications, and the controller may interpret these inputs and in response, may issue control commands to the other components in the device 300.

In an example embodiment, the device 300 includes a library, such as a library 304. The library 304 is configured to store the information regarding the highlights of the media content. The applications, such as the application A1, the application A2, and the application A3, may link to the library 304. In an example embodiment, the applications may link to the library 304 through the controller 302. In an example embodiment, the library 302 may include algorithms, such as, highlight algorithm for determining the highlights of a various granularities. In an example embodiment, the library 304 may provide highlights of various granularities as requested by the applications, and other requisite information to the applications. In an example embodiment, the library 304 may be an example of the memory means. An example of the memory means may include the memory, such as the memory 204. In an example embodiment, the library 304 may store the information regarding the highlights and the associated granularity levels in the form of tables.

In an example embodiment, the device 300 may include a highlight module 306 embodied in the library 304 or in communication with the library 304. The highlight module 306 module 306 for facilitating the applications in determining selection of the highlights stored in the device 300. In an example embodiment, the highlight module 306 may include a selection algorithm for selecting the highlights. The selection algorithm may be applied on the second granularity level highlights for extracting the media highlights corresponding to the first granularity level highlights. In an example embodiment, the highlight module 306 may be an example of the processing means. An example of the processing means may include the processor, such as the processor 202.

In an example embodiment, the device 300 may include a storage such as a storage 308 for storing thumbnails associated with the highlights of various granularity levels. In an example embodiment, the thumbnails corresponding to different granularity level highlights may be stored in different tables in the storage 308, such as Table 1, Table 2, Table N, and the like. In another example embodiment, the thumbnails associated with highlights of various granularity levels may be stored in other forms also, such as, arrays. In an example embodiment, the storage 308 may be an example of the memory means. An example of the memory means may include the memory, such as the memory 204.

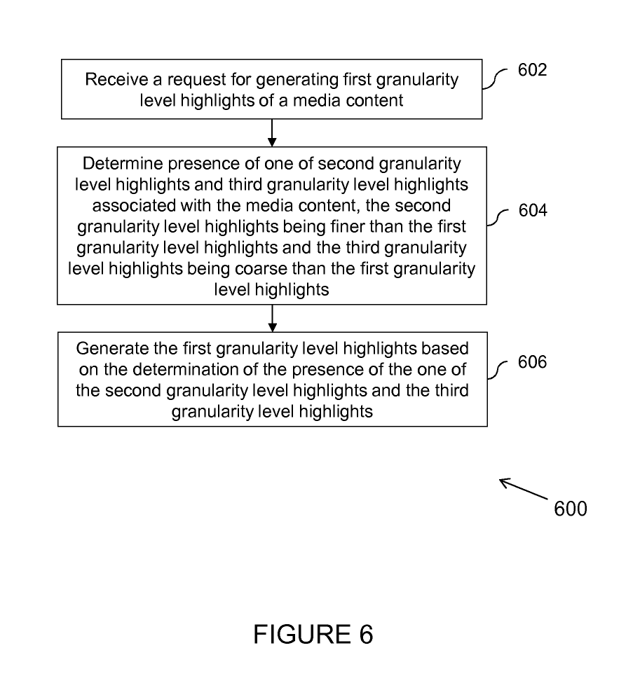

The controller 302, the library 304, the highlight module 306, and the storage 308, may be implemented as a hardware module, a software module, a firmware module or any combination thereof. In an example embodiment, the controller 302 may facilitate execution of instructions received by the device 300, and a battery unit for providing requisite power supply to the device 300. The device 300 may also include requisite electrical connections for communicably coupling the various modules of the device 300. A method for managing media content is explained in FIG. 6.

In an alternate example embodiment, the highlights such as the first granularity level highlights, the second granularity level highlights, and the third granularity level highlights may be stored in one or more devices associated with a cloud. Examples of the one or more devices may include a server.

FIG. 4 is a block diagram illustrating generation of highlights from the highlights associated with coarse granularity level. The block diagram illustrates a media content, such as, a media content 402 having media segments such as media segments 402a, 402b, 402c, 402d, 402e and the like. In an example embodiment, the length of each of the media segments may be different, as illustrated in FIG. 4.

In an example embodiment, the media content 402 may have a single frame or thumbnail corresponding to highlights of the media segments 402a, 402b, 402c, 402d, 402e. The frame corresponding to the highlights of each of the media segments may be representative of the content of the respective media segments. For example, corresponding to the media segments 402a, 402b, 402c, 402d, the media content 402 may include frames such as frame X1 404, frame X2 406, frame X3 408, and frame X4 410, respectively. In an example embodiment, frames such as the frame X1 404, the frame X2 406, the frame X3 408, and the frame X4 410 may include a thumbnail associated with the respective media segments. The thumbnails may be representative of the content of respective media segments. In an example embodiment, the thumbnails may indicate the granularity level of the highlights of the media content. For example, as illustrated in FIG. 4, the granularity level of the media content having highlight frames X1, X2, X3, and X4 is X. In an example embodiment, the thumbnails corresponding to a granularity level may be stored in a database (DB). For example, the thumbnails corresponding to the ‘X’ granularity level highlights is stored in the database in form of a table, such as a database table 412. Alternatively, the thumbnails corresponding to a granularity level may be stored in an array.

When an application requests for presenting highlights (or associated frames) of a granularity level higher than the granularity level X, say a granularity level (X+i), the requisite highlights that are absent in the granularity level X highlights may be extracted from the media segments corresponding to the (X+i) granularity from the media content. In an example embodiment, the highlights may be extracted by decoding the media content. The highlights of the granularity level (X+i) are finer than the highlights of the granularity level X. This For example, as illustrated in FIG. 4, an application may request for finer granularity level highlights (X+i) than are present in the database table of granularity level X. As such, the finer granularity level highlights, namely, frame (X+i)1 414 and frame (X+i)2 416 may be generated, and the remaining highlights such as frame X1 and frame X2 may be referenced from the database table X. In an example embodiment, the highlights for granularity level (X+i) may be stored in a table, such as a database table (X+i) 418. In an example embodiment, storing the highlights may indicate referencing the already stored highlights in the database. For example, the already generated highlights associated with the granular level X, namely, the frame X1 and the frame X2 may be referenced in the database table (X+1i) 418, as illustrated in FIG. 4. During the generation of the (X+i) granularity level highlights, the already stored highlights may be utilized, and generating only those highlights that may be needed for finer representation, thereby optimizing the usage of the storage space and memory utilization.

FIG. 5 is a block diagram illustrating generation of highlights from the highlights associated with a finer granularity level. For example, the media content may include frames such as frames X1 404, frame X2 406, frame X3 408, and frame X4 410. As discussed with reference to FIG. 4, the frames X1, X2, X3, X4 associated with a granularity level ‘X’ may be stored in the database in a table, for example the database table 412.

When an application requests for presenting highlights of a granularity level lower than the granularity level X, say the granularity level (X−i), it may be determined whether such highlights are already existing in the database. In an example embodiment, the database may contain highlights generated by the applications of granularity level higher than that of the granularity level ‘X’, for example, by the applications of granularity level (X+i). In an example embodiment, when the presence of the second (X+i)th granularity level highlights is determined, the media highlights corresponding to the Xth granularity level may be extracted from the (X+i)th granularity level highlights. In an example embodiment, a selection algorithm, such as a highlight selection algorithm 502 may be applied to select highlights of the granularity level (X−i), as illustrated in FIG. 5. The selection algorithm 502 may be specific to media content, and may vary based on the media content. For example, for generating the highlights of granularity level (X−i), only the frame X1 and the frame X4 may be selected. In an example embodiment, the selected frames X1 and X4 may be referenced in a DB table (X−i) 504 corresponding to the highlights of the granularity level (X−i).

In another example embodiment, when the presence of the second granularity level highlights is determined, the first granularity level highlights may be generated by partially utilizing second granularity level highlights or only using as a hint. For example, at least a portion of a media segmentation and other related information such as an information associated with the first granularity level highlights may be extracted from the second granularity level highlights for constructing the first granularity level highlights. Also, additional first granularity level highlights may be constructed from the media content. An example of the additional information may include ‘type of the media content’, distribution of the media content, and the like.

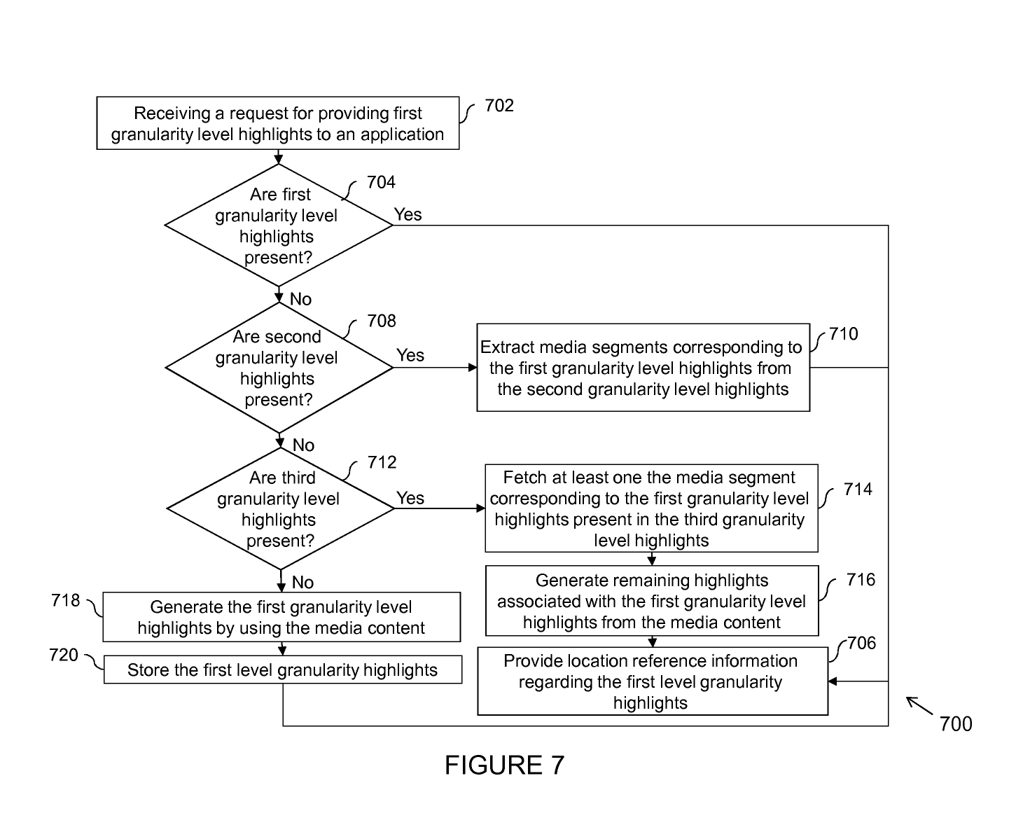

As an exemplary illustration, it may be desired to vary the distribution of a media content, such as a news report, by, for example, increasing the duration of appearance of a news reader in the first granularity level highlights. In such as scenario, the media segments comprising the news reader and other related information for example, variation in the distribution of the news report may be extracted from the second level granularity highlights, and additional fresh media highlights may be reconstructed from the media content to generate the first granularity level highlights. A method for managing media content is explained in FIGS. 6 and 7.

FIG. 6 is a flowchart depicting an example method 600 for managing media content by organizing highlights of the media content into multiple discrete granularity levels in accordance with an example embodiment. The method 600 depicted in the flow chart may be executed by, for example, the apparatus 200 of FIG. 2. Examples of the apparatus 200 include, but are not limited to, mobile phones, personal digital assistants (PDAs), laptops, and any equivalent devices.

The method 600 describes steps for managing media content. Examples of the media content may include, but are not limited to video content, audio content, textual content, and a combination thereof. Managing of the media content may include generating of highlights of different granularity levels based on requirements of different applications, and efficient storage thereof.

At block 602, a request for providing first granularity level highlights is received. In an example embodiment, the request may be received from a multimedia application such as a ‘Media Gallery’ application. For example, the ‘Media Gallery’ application may request for presenting a first granularity level highlight representing an animated thumbnail in the ‘Media Gallery’.

At block 604, presence of at least one of second granularity level highlights and third granularity level highlights associated with the media content is determined. In an example embodiment, the second granularity level highlights are finer than the first granularity level highlights. In an example embodiment the third granularity level highlights are coarse than the first granularity level highlights.

At block 606, the first granularity level highlights are generated based on the determination of the presence of one of the second granularity level highlights and the third granularity level highlights. In an example embodiment, when the presence of the second granularity level highlights is determined, the first granularity level highlights may be generated by extracting media segments corresponding to the first level highlights from the second granularity level highlights that are finer than the first level highlights. In an example embodiment, the first granularity level highlights may be generated by using the third granularity level highlights when the second granularity level highlights are determined to be absent. In an example embodiment, when the presence of third granularity level highlights is determined, the first granularity level highlights may be generated by fetching at least one media segment corresponding to the first granularity level highlights present in the third granularity level highlights, and retrieving the remaining first granularity level highlights from the media content.

FIG. 7 is a flowchart depicting an example method 700 for managing media content by organizing highlights into multiple discrete granularity levels in accordance with another example embodiment. The method 700 depicted in flow chart may be executed by, for example, the apparatus 200 of FIG. 2.

Operations of the flowchart, and combinations of operation in the flowchart, may be implemented by various means, such as hardware, firmware, processor, circuitry and/or other device associated with execution of software including one or more computer program instructions. For example, one or more of the procedures described in various embodiments may be embodied by computer program instructions. In an example embodiment, the computer program instructions, which embody the procedures, described in various embodiments may be stored by at least one memory device of an apparatus and executed by at least one processor in the apparatus. Any such computer program instructions may be loaded onto a computer or other programmable apparatus (for example, hardware) to produce a machine, such that the resulting computer or other programmable apparatus embody means for implementing the operations specified in the flowchart. These computer program instructions may also be stored in a computer-readable storage memory (as opposed to a transmission medium such as a carrier wave or electromagnetic signal) that may direct a computer or other programmable apparatus to function in a particular manner, such that the instructions stored in the computer-readable memory produce an article of manufacture the execution of which implements the operations specified in the flowchart. The computer program instructions may also be loaded onto a computer or other programmable apparatus to cause a series of operations to be performed on the computer or other programmable apparatus to produce a computer-implemented process such that the instructions, which execute on the computer or other programmable apparatus provide operations for implementing the operations in the flowchart. The operations of the method 700 are described with help of apparatus 200. However, the operations of the method 700 can be described and/or practiced by using any other apparatus.

The media content may be video content, audio content, textual content or a combination thereof. At block 702, a request for providing first granularity level highlights associated with a media content is received. In an example embodiment, the request may be received from an application, for example, an application pertaining to ‘frame stepping’, ‘presentation stepping’, or any other multimedia application. The ‘frame stepping’ application allows stepping a current playback position forward or backward by a number of frames.

At block 704, it may be determined whether the first level granularity highlights are present. In an example embodiment, the first level granularity highlights may be stored in the memory, such as the memory 202 of the apparatus 200. In another example embodiment, the first level granularity highlights may be stored in one or more devices associated with a cloud. Examples of the one or more devices may include a server. If at block 704, it is determined that the first level granularity highlights are present, the first level granularity highlights may be provided to the application at block 706. In an example embodiment, providing the first level granularity highlights includes providing a location reference information regarding an existing location of the first level granularity highlights to the application. However, if at block 704, the first level granularity highlights are determined to be absent, it is determined at block 708 whether second level granularity highlights are present. In an example embodiment, the second level granularity highlights may be stored in the memory, such as the memory 202 of the apparatus 200. In another example embodiment, the first level granularity highlights may be stored in one or more devices associated with a cloud. Examples of the one or more devices may include a server. In an example embodiment, the second level granularity highlights are finer than the first level granularity highlights.

If at block 708, it is determined that the second level granularity highlights are present, the media segments corresponding to the first level granularity highlights may be extracted from the second level granularity highlights at block 710. In the present embodiment, the second level granularity highlights are finer than the first level granularity highlights. The extraction of the first level granularity highlights from the finer second level granularity highlights is already explained in FIG. 5. A location reference information of the extracted first granularity level highlights may be provided to the application, at block 706. In an example embodiment, the reference information of the extracted highlights may be stored in a database, for example, in a database table or on a server.

If at block 708, the second level granularity highlights are determined to be absent, it is determined at block 712 whether third level granularity highlights are present. If it is determined at block 712, that the third level granularity highlights are present, then at least one of the media segment corresponding to the first granularity level highlights present in the third granularity level highlights may be fetched. In an example embodiment, the third granularity level highlights are coarse than the first granularity level highlights. As explained in FIG. 4, the first level granularity highlights may be extracted from the coarse third level granularity highlights by fetching at least one the media segment corresponding to the first granularity level highlights present in the third granularity level highlights, at block 714. The remaining highlights required for complete generation of the first granularity level highlights may be generated by selecting the highlights from the media content, at block 716. In an example embodiment, the reference information regarding the first granularity level highlights may be provided at block 706.

If, however, at block 712, the third granularity level highlights are determined to be absent, the first granularity level highlights may be generating by using the media content at block 718. The generated first granularity level highlights may be stored at block 720. In an example embodiment, the generated first granularity level highlights may be stored in a database. In an example embodiment, the database may store the first granularity level highlights in form of a table. In another embodiment, the database may store the first granularity level highlights in form of an array.

In an example embodiment, a processing means may be configured to perform some or all of: receiving a request for providing a first granularity level highlights associated with a media content; determining presence of at least one of second granularity level highlights and third granularity level highlights associated with the media content, the second granularity level highlights being finer than the first granularity level highlights and the third granularity level highlights being coarse than the first granularity level highlights; and generating the first granularity level highlights based on the determination of the presence of one of the second granularity level highlights and the third granularity level highlights. An example of the processing means may include the processor 202, which may be an example of the controller 108.

It will be understood that although the method 700 of FIG. 7 shows a particular order, the order need not be limited to the order shown, and more or fewer blocks may be executed, without providing substantial change to the scope of the present disclosure.

Without in any way limiting the scope, interpretation, or application of the claims appearing below, a technical effect of one or more of the example embodiments disclosed herein is to managing media content in an electronic device. Managing of the media content may refers to generation and storage of highlights of different granularities associated with the media content. The highlights of different granularities may be generated and stored in different database for efficient storage and retrieval thereof. These highlights once generated could be used for different use cases based on the applications. For example, highlights once generated may be used for applications requiring coarse granularity level or finer granularity level highlights than the granularity level of the generated highlights. This enhances optimization of the storage space and management of highlights, thereby resulting in optimized space and CPU utilization. The media highlights can be used by applications such as text editor, video summarization, audio player, and other such multimedia applications.

Various embodiments described above may be implemented in software, hardware, application logic or a combination of software, hardware and application logic. The software, application logic and/or hardware may reside on at least one memory, at least one processor, an apparatus or, a computer program product. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of an apparatus described and depicted in FIGS. 1 and/or 2. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present disclosure as defined in the appended claims.

1-39. (canceled)

40. A method comprising:
receiving a request for providing a first granularity level highlights associated with a media content;
determining presence of at least one of second granularity level highlights and third granularity level highlights associated with the media content, the second granularity level highlights being finer than the first granularity level highlights and the third granularity level highlights being coarse than the first granularity level highlights; and
generating the first granularity level highlights based on one of the second granularity level highlights or the third granularity level highlights.

41. The method as claimed in claim 40, wherein the media content is one of video content, audio content, textual content, and a combination thereof.

42. The method as claimed in claim 40, wherein generating the first granularity level highlights based on the second granularity level comprises: extracting media highlights corresponding to the first granularity level highlights from the second granularity level highlights.

43. The method as claimed in claim 42, wherein extracting the media highlights corresponding to the first granularity level highlights comprises applying a selection algorithm on the second granularity level highlights.

44. The method as claimed in claim 40, wherein generating the first granularity level highlights based on second granularity level comprises:
extracting, at least a portion of a media segmentation and other related information, from the second granularity level highlights; and
generating the first granularity level highlights from the media content based on the extracted at least a portion of the media segmentation and the information.

45. The method as claimed in claim 40, wherein generating the first granularity level highlights based on the third granularity level comprises:
fetching at least one media segment corresponding to the first granularity level highlights present in the third granularity level highlights; and
retrieving, from the media content, the first granularity level highlights absent from the third granularity level highlights.

46. The method as claimed in claim 40, generating the first granularity level highlights by utilizing the media content in the absence of the second granularity level and the third granularity level.

47. An apparatus comprising:
at least one processor; and
at least one memory comprising computer program code, the at least one memory and the computer program code configured to, with the at least one processor, cause the apparatus at least to perform:
receive a request for providing first granularity level highlights associated with a media content;
determine presence of at least one of second granularity level highlights and third granularity level highlights associated with the media content, the second granularity level highlights being finer than the first granularity level highlights and the third granularity level highlights being coarse than the first granularity level highlights; and
generate the first granularity level highlights based on one of the second granularity level highlights or the third granularity level highlights.

48. The apparatus as claimed in claim 47, wherein the media content is one of video content, audio content, textual content, and combination thereof.

49. The apparatus as claimed in claim 47, wherein the apparatus is further caused, at least in part, to perform: extract media segments corresponding to the first granularity level highlights from the second granularity level highlights to generate the first granularity level highlights based on second granularity level.

50. The apparatus as claimed in claim 49, wherein the apparatus is further caused, at least in part, to perform: apply a selection algorithm on the second granularity level highlights to extract the media highlights corresponding to the first granularity level highlights.

51. The apparatus as claimed in claim 47, wherein to generate the first granularity level highlights based on the second granularity level highlights, the apparatus is further caused, at least in part, to perform:
extract, at least a portion of the media segmentation and other related information, from the second granularity level highlights; and
generate the first granularity level highlights from the media content based on the extracted at least a portion of the media segmentation and the information.

52. The apparatus as claimed in claim 47, wherein to generate the first granularity level highlights based on the third granularity level highlights, the apparatus is further caused, at least in part, to perform:
fetch at least one the media segment corresponding to the first granularity level highlights present in the third granularity level highlights; and
retrieve, from the media content, the first granularity level highlights absent from the third granularity level highlights.

53. The apparatus as claimed in claim 47, wherein the apparatus is further caused, at least in part, to perform: generate the first granularity level highlights by utilizing the media content in the absence of the second granularity level highlights and the third granularity level highlights.

54. A computer program comprising a set of instructions, which, when executed by one or more processors, cause an apparatus at least to perform:
receive a request for providing a first granularity level highlights associated with a media content;
determine presence of at least one of second granularity level highlights and third granularity level highlights associated with the media content, the second granularity level highlights being finer than the first granularity level highlights and the third granularity level highlights being coarse than the first granularity level highlights; and
generate the first granularity level highlights based on one of the second granularity level highlights or the third granularity level highlights.

55. The computer program as claimed in claim 54, wherein the media content is one of video content, audio content, textual content, and a combination thereof.

56. The computer program as claimed in claim 54, wherein the apparatus is further caused, at least in part, to perform: extract media segments corresponding to the first granularity level highlights from the second granularity level highlights to generate the first granularity level highlights.

57. The computer program as claimed in claim 54, wherein to generate the first granularity level highlights based on the second granularity level highlights, the apparatus is further caused, at least in part, to perform:
extract, at least a portion of the media segmentation and other related information, from the second granularity level highlights; and
generate the first granularity level highlights from the media content based on the extracted at least a portion of the media segmentation and the information.

58. The computer program as claimed in claim 54, wherein to generate the first granularity level highlights based on the third granularity level highlights, the apparatus is further caused, at least in part, to perform:
fetch at least one the media segment corresponding to the first granularity level highlights present in the third granularity level highlights; and
retrieve, from the media content, the first granularity level highlights absent from the third granularity level highlights.

59. The computer program as claimed in claim 54, wherein the apparatus is further caused, at least in part, to perform: generate the first granularity level highlights by utilizing the media content in the absence of the second granularity level highlights and the third granularity level highlights.
